(19) United States
(12) Patent Application Publication
(10) Pub. No.: US 2022/0180696 A1
(43) Pub. Date: Jun. 9, 2022

(54) GAMING TERMINAL WITH PSEUDO PROGRESSIVE FEATURE

(71) Applicant: Craig K. Potts, Scottsdales, AZ (US)

(72) Inventor: Craig K. Potts, Scottsdales, AZ (US)

(21) Appl. No.: 17/643,168

(22) Filed: Dec. 7, 2021

Related U.S. Application Data
(60) Provisional application No. 63/122,308, filed on Dec. 7, 2020.

(51) Int. Cl. G07F 17/32

(52) U.S. Cl. CPC G07F 17/3216; G07F 17/3286; G07F 17/3223; G07F 17/3211

(57) ABSTRACT

A gaming console is configured to have multiple display screens, and thus allowing for the presentation of multiple gaming options for the user. Further, game operations are configured to provide different but related games on the display screens, such as a base game and a related progressive-type game. The control processor within the console is configured to provide these game opportunities. While also following rules required by the local jurisdiction. In some instances, these may be pull-tab or bingo-based games that are presented to a user in a unique and inviting format.

### BACKGROUND

Creating excitement and opportunity for individuals is a constant goal for those involved in the casino and gaming industry. One portion of this activity is the creation of new games and/or opportunities, which increases excitement and desire for users, thus providing new entertainment options for many individuals. Further, creating new games and new gaming opportunities which are easy to understand while also enticing can always be challenging and rewarding at the same time.

Electronic gaming has been widely popular for many years and continues to evolve, providing playing opportunities for many. Gaming consoles or gaming systems can take many forms, depending on the jurisdiction or philosophy involved. That said, the rules, laws and practices of each jurisdiction vary, thus making the development of games challenging. As one example, progressive games, linked machines and comingled devices are prohibited in many jurisdictions.

Bingo gaming devices and pull-tab gaming devices are two well-known versions of electronic gaming consoles that provide player interest while also meeting the needs of certain jurisdictions. Other appropriate game consoles could be based upon lottery, nudge, sweepstakes, skill, and chance games.

### SUMMARY

To provide added excitement and opportunity, a gaming console is configured to the play of support the play of a progressive themed game. While several variations are possible, some of the contemplated embodiments this will support the progressive themed game as part of pull-tab or bingo games. Similar concepts could be used in a lottery game, sweepstakes game, skill game, nudge games, or multiple versions of other games that can be played on a video gaming console.

### BRIEF DESCRIPTION OF THE DRAWINGS

FIG. 1 presents a front view of an exemplary gaming console;

FIG. 2 is a flowchart outlining the general game play process which incorporates additional features;

FIG. 3 is a schematic diagram of the electronic components contained within the gaming console; and

FIG. 4 shows one example of a playing experience provided by the gaming console.

### DESCRIPTION

In an effort to provide additional gaming opportunities for users, the embodiments disclosed herein provide multiple display screens on a gaming console, which allows or supports the simultaneous play of multiple games. In one embodiment, two displays or screens are presented to the user, one playing a first game while the second plays a second game. Further, one alternative includes the second game being presented as a progressive or enhanced game which can be played by a user. In another embodiment, these are both simultaneous pull-tab games, which can be designed and configured to have user interfaces which widely vary. In a further embodiment, Bingo-type games are incorporated, again allowing for the simultaneous play of two games by a single user at the same time.

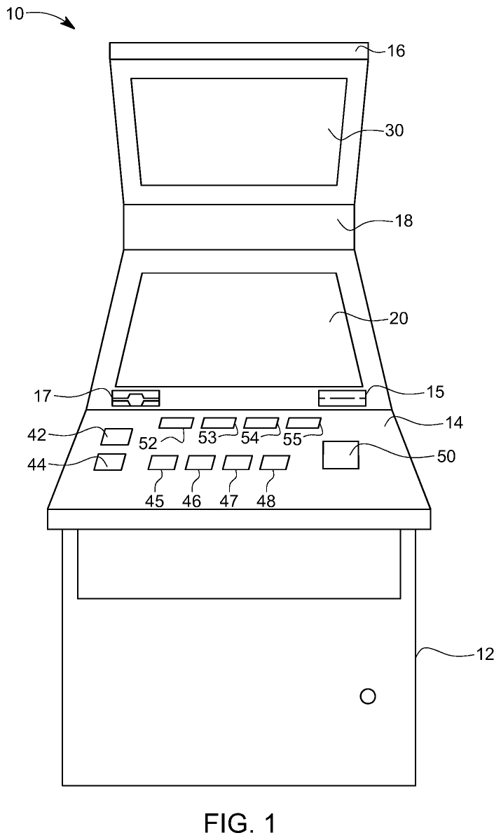

Turning now to FIG. 1, one example embodiment of a gaming console 10 is illustrated. As shown, gaming console 10 includes a main housing 12 which is configured to support a number of separate components. In particular, housing 12 supports a control panel 14, a first display 20 and a second display 30. Housing 12 also supports a banner panel 16, which is generally configured to support advertising or promotional signage. Housing 12 also supports a speaker panel 18 which houses audio speakers, thus allowing for sound effects to be incorporated into the user's gaming experience. Also supported by housing 12 is a bill exchanger 15 and a ticket printer 17. As will be recognized, bill exchanger 15 is configured to accept currency, and may also be configured to accept printed tickets or vouchers of various types. In a similar manner, printer 17 is configured to print vouchers or payment tickets, generally when a user desires to cash out.

As also illustrated, control panel 14 includes a number of control buttons which generally provide a user interface, allowing a user to provide appropriate playing commands. In this particular embodiment, control panel 14 includes a pair of game select buttons 42 and 44. As will be discussed in further detail below, game control buttons 42 and 44 provide a user with the ability to select different games. Further, control panel 14 includes a collection of bet amount buttons 45, 46, 47 and 48. These bet amount buttons 45-48 provide a user with the ability to easily select an amount for the desired wager or bet while games are being played. Also supported on control panel 14 is a play button 50 which is generally configured to allow play to commence, once all playing options are selected. As will be further described below, game console 10 is further configured to support the offering of progressive options to users. To allow a user to select play of various progressive options, a plurality of progressive option buttons 52, 53, 54 & 55 are positioned on control panel 14.

As mentioned above, game console 10 of the disclosed embodiment includes a first display 20 and a second display 30. It is generally contemplated that first display 20 and second display 30 are used for different purposes. More specifically, game console 10 will use first display 20 to present and support the play of a base game, while second display 30 will accommodate/support the play of enhanced or progressive game options. In this embodiment, it is generally contemplated that first display 20 and second display 30 could be configured as any well-known display device. Further, first display 20 and second display 30 could be touchscreen enabled displays, thus allowing further user interaction with game console 10. These display devices could include well known display devices such as Liquid Crystal Displays (LCD), LED monitors, etc. It is also possible to carry out the necessary game play using multiple separate display devices, or a single display device partitioned into a plurality of displays.

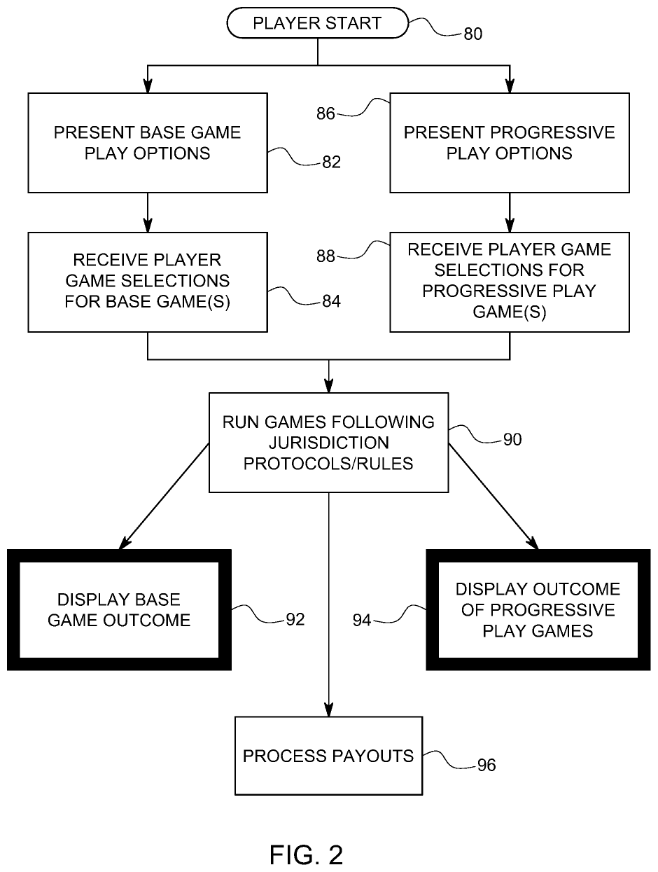

To provide a different playing experience for players, the present game console is configured to allow for the addition of a supplemental game option, such as a progressive game or a progressive-like game option. FIG. 2 generally illustrates the playing process followed by users and the systems contained within console 10. More specifically, a user will commence game play at step 80, which could occur in many different ways such as hitting any button or the touchscreen. After initiation, the systems of game console 10 will present base game options at step 82, and subsequently allow player make selections related to the base game at step 84. Simultaneously, the systems within game console 10 will present supplemental game options at step 86 and allow user selections at step 88. In some embodiments, the supplemental game option simply provides a user with the ability to participate in the supplemental game or to opt out. Once selections are made, game console 10 will commence game play at step 90. As suggested above, the mechanisms that cause the game(s) to progress can vary depending on the jurisdiction and licensing rules for the institution supporting game console 10. As will be appreciated, this could include a pull-tab based or bingo based game methodology. Other alternatives are possible and contemplated to be within the capabilities for game console 10 including games of chance, lottery based games, games of skill, sweepstakes based games, nudge games, etc. As game play progresses, the results for the base game are displayed at step 92, while game results for the supplemental game options are simultaneously displayed. As suggested above, it is contemplated that the supplemental game results would be displayed on a different screen. In another embodiment, where the supplemental game is a progressive game, the display of results could be presented on a separate display, such as a large screen placed above game console 10. Lastly, the payouts are processed at step 96.

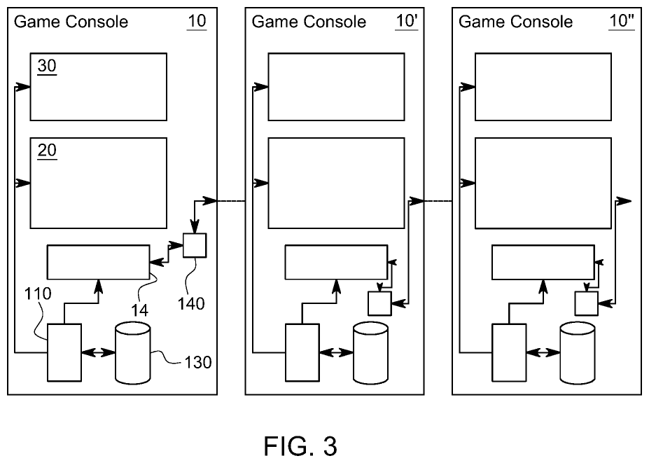

Turning now to FIG. 3, a schematic diagram is presented showing the internal components of the gaming console 10. In this embodiment, a first game console 10, a second game console 10′ and a third game console 10″ are configured to communicate with one another, thereby creating a linked gaming system 100. Generally, it is contemplated that all components within the three illustrated game consoles (i.e. first game console 10, second game console 10′ and third game console 10″) would be identical and would have an external configuration similar to that set forth in FIG. 1. With this understanding, the components housed within first game console 10 are described in further detail below.

As illustrated in FIG. 3, game console 10 includes several cooperating components, including a processor 110, first display device 20, second display device 30, control panel 14 and a storage device 130. As illustrated, processor 110 is operatively connected to control panel 14, thus allowing it to receive electrical signals indicative of player commands. Further, processor 110 is operatively connected to bill exchanger 15 and printer 17 (not shown in FIG. 3).

It will be recognized that processor 110 will coordinate game operations for game console 10. Programing for processor 110 is stored in memory device 130 and will cause processor 110 to be configured in a manner to carry out many different types of games. Further, to provide additional features and functionality, processor 110 is connected to a network interface 140, thus allowing further communication with other components and other systems.

In an alternative embodiment, a plurality of consoles will each have a processor which is in communication with a host processor, so that multiple consoles will be able to support the coordinated play of games. As an example, each console may be able to support a separate base game while all of the consoles participate in a single supplemental game. In this embodiment, the supplemental game will be configured as a progressive-like game. Further, each of the consoles could be configured so that host processor supports the play of various base games as a single game. Again, each situation will comply with jurisdictional requirements (as discussed in further detail below).

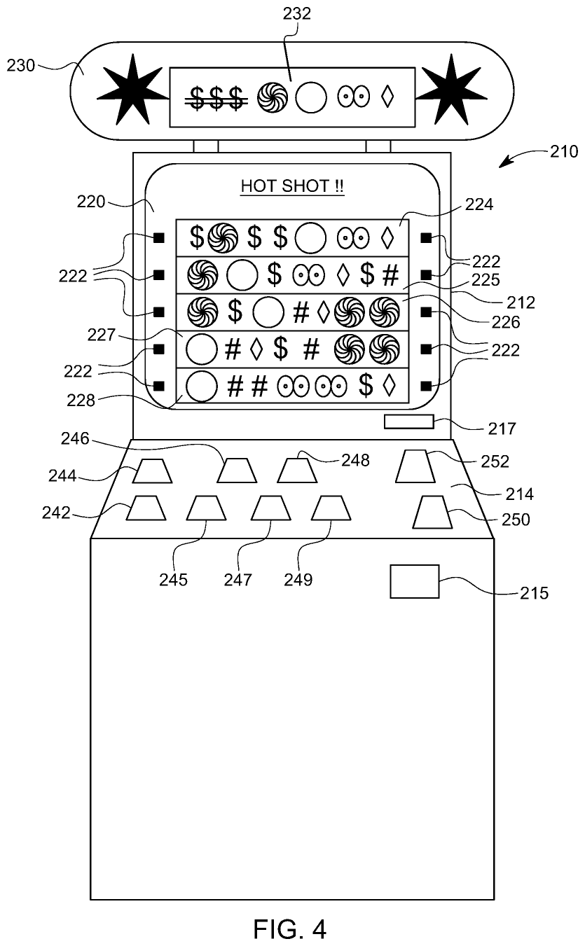

As one example of the gaming experience contemplated, an alternative game console 210 is illustrated in FIG. 4. In this embodiment, console 210 includes a housing 212 which is configured to support a main display 220, an alternative/bonus display 230, a player interface 214, a bill changer 215 and a ticket printer 217. Again, a user/player will interact with console 210 using multiple buttons positioned on player interface 214, which include a pair of game select buttons 242 and 244, a set of bet buttons 245-249 which will allow a player to bet different amounts and/or different bets (e.g. single line, 5 lines, all lines, etc.). In this embodiment, five paylines 224, 225, 226, 227, 228 are shown. Further, payline indicators 222 exist on each side of the paylines, thus allowing the display to identify may winning combinations as the game is played, such as diagonals, “v” lines, etc. Console 210 also includes a play button 250 and a play progressive button 252. It is contemplated that the user would enable progressive play by hitting the play progressive button 252, prior commencing a game using play button 250. Naturally, several alternatives are available.

Although not shown, a processor 270 is housed within alternative game console 210 which is configured to coordinate the operation of display device 220 and alternate display 230. In this embodiment, alternate display 230 is used exclusively to display the results of the progressive play option. Instructions provided to processor 270 will allow for the play of the based game as instructed by the user, along with the participation in the progressive play option.

Depending on the jurisdiction where alternative console 210 is placed, it is contemplated that the progressive option will involve the play of a separate game using the required game criteria. For example, if alternative game console 210 is placed in a jurisdiction limited to pull-tab machines, the progressive game will be implemented as a separate pull-tab based game, but the odds and payouts may be modified so that the game will appear to more closely resemble a progressive game. As an alternative embodiment, the first game and second game could be based upon a single pull-tab based deck, as directed by the particular jurisdiction. Similar rule would be followed if the first game and second game are bingo based games—the first game might be based upon a first bingo draw or drop (i.e. simulated bingo drop or set of bingo numbers), while the second game may be based upon a second bingo draw or drop. Alternatively, both games may be based upon a single set of bingo numbers, with the odds for the various games adjusted to meet the desires and requirements of the game designers. It will be further understood that the processor can incorporate the game requirements required by various jurisdictions, and could include bingo-based games, pull-tab based games, games of chance, etc.

In addition to the variations outlined above, multiple consoles could be configured to participate in the gaming methodology outlined above. In this case each console may support the play of a base game, while a single alternative payout game is supported, thereby providing the feel of a linked progressive game, while still following the rules of the local jurisdiction.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A gaming machine configured to allow a user to participate in multiple games, the gaming machine comprising:
a housing;
a first display supported by the housing and positioned to be easily viewable by the user;
a second display also supported by the housing and positioned to be easily viewable by the user;
a user interface configured to allow player interaction with the gaming machine;
a processor contained within the housing and operatively coupled to the user interface, the first display and the second display; and
memory configured to store programming that will allow the processor to facilitate the simultaneous play of a base game using and a supplemental game, wherein play of the base game and the supplemental game will follow a set of predetermined jurisdiction parameters while also being presented using different themes, wherein the base game is controlled by the user interface and provides multiple play options and the results will be displayed on the first display, and wherein the supplemental game has alternative odds which support a higher payout than the base game.

2. The gaming machine of claim 1 wherein the base game and the supplemental game are bingo games.

3. The gaming machine of claim 2 wherein the base game and the supplemental game are based upon a single bingo draw.

4. The gaming machine of claim 1 wherein the base game and the supplemental game are pull-tab based games.

5. The gaming machine of claim 4 wherein the base game and the supplemental game are based upon a single pull-tap deck.

6. The gaming machine of claim 1 wherein the first display and the second display are presented on a single display device, with the first display presented in a first portion of the single display device and the second display presented in a second portion of the single display device.

7. The gaming machine of claim 1 wherein the second display is attached to a top portion of the housing and presents the supplemental game as a progressive-like game.

8. A gaming system configured to allow a user to participate in multiple games, the gaming machine comprising:
a plurality of displays;
a user interface configured to allow player interaction with the gaming machine;
a host processor contained operatively coupled to the user interface and the plurality of displays; and
memory configured to store programming that will allow the host processor to facilitate the simultaneous play of a plurality of bases game and a supplemental game, wherein play of the plurality of base games and the supplemental game will follow a set of predetermined jurisdiction parameters while also being presented using different themes, wherein each of the plurality of base games is controlled by the user interface and provides multiple play options and the results will be displayed on at least one of the plurality of displays, and wherein the supplemental game has alternative odds which support a higher payout than the base game and is presented on another one of the plurality of displays.

9. The gaming system of claim 8 further comprising a housing configured to support at least a first display and a second display of the plurality of displays in a manner to be easily viewable by the user, and wherein the first display will present the base game and the second display will present the supplemental game.

10. The gaming system of claim 9 wherein the second display is positioned above a top portion of the housing, and the supplemental game is a progressive-like game.

11. The gaming system of claim 8 wherein the plurality of base games and the supplemental game are bingo games.

12. The gaming system of claim 11 wherein the plurality of base games and the supplemental game are based upon a single bingo draw.

13. The gaming system of claim 8 wherein the plurality of base games and the supplemental game are pull-tab based games.

14. The gaming system of claim 13 wherein the plurality of base games and the supplemental game are based upon a single pull-tap deck.

15. The gaming system of claim 8 wherein each of the plurality of base games and the supplemental game are games of chance.

16. The gaming system of claim 8 further comprising a plurality of housings, with each housing configured to support at least a first housing display and a second housing display of the plurality of displays in a manner to be easily viewable by the user, and wherein each of the first housing displays will present an instance of the base game and each of the second housing displays will present the supplemental game, and wherein each housing comprises a housing processor in communication with the host processor to allow the play of plurality of base game and the supplemental game.
